(19) United States
(12) Patent Application Publication
(10) Pub. No.: US 2022/0005483 A1
(43) Pub. Date: Jan. 6, 2022

(54) Group Chat Voice Information Processing Method and Apparatus, Storage Medium, and Server

(71) Applicant: Gree Electric Application, Inc. of Zhuhai, Zhuhai, Guangdong (CN)

(72) Inventor: Mingzu YU, Zhuhai, Guangdong (CN)

(21) Appl. No.: 17/296,846

(22) PCT Filed: Oct. 10, 2019
(86) PCT No.: PCT/CN2019/110320

§ 371 Date: May 25, 2021

(30) Foreign Application Priority Data
Jan. 11, 2019 (CN) 201910026763.6

(51) Int. Cl. G10L 17/14; H04L 12/18; G06F 40/279; G10L 17/22

(52) U.S. Cl. CPC G10L 17/14; G10L 17/22; G06F 40/279; H04L 12/18

(57) ABSTRACT

A group chat voice information processing method and apparatus, a storage medium and a server are provided. The method includes: receiving first group chat voice information of a first user; determining a second user associated with the first group chat voice information; and when the first group chat voice information is sent to a target chat group, marking the second user as a target user of the first group chat voice information.

### CROSS-REFERENCE TO RELATED APPLICATION

The present disclosure claims priority to Chinese Patent Application No. 201910026763.6, filed on Jan. 11, 2019 and entitled “Group chat Voice Information Processing Method and Apparatus, Storage Medium, and Server”, the contents of which are incorporated herein by reference.

### TECHNICAL FIELD

The present disclosure relates to the technical field of Internet, and in particular to a group chat voice information processing method and apparatus, a storage medium, and a server.

### BACKGROUND

With the popularization of mobile terminals, people are more and more inseparable from mobile terminals such as mobile phones in daily life, and the use of mobile terminals such as mobile phones for shopping, chatting, games, tourism and working is more and more frequent. The use ratio of a chat application is very large, the convenience and rapidity of voice input commonly used in the chat application are also recognized by a large number of users, a user can directly input voice into a chat interface by speaking to a microphone of a mobile phone, other users can listen to the voice. The user may select voice input when typing speed is slow or text input is inconvenient. However, there are some problems with using the voice input in our daily life. For example, when the voice input is in a single-to-single chat, the user may determine that voice information is associated with this user, but when the voice input is in a group chat, a large amount of voice information may occur, the user needs to listen to all the voice information one by one to determine whether the voice information is associated with this user. When the user listens to all the voice information, listening to a large amount of voice information unassociated with the user wastes the time and energy of the user, and the user experience is poor.

### SUMMARY

At least some embodiments of the present disclosure provide a group chat voice information processing method and apparatus, a storage medium and a server, so as at least to partially solve a problem in the related art that a user needs to listen to voice information in a chat group one by one to waste time and energy.

An embodiment of the present disclosure provides a group chat voice information processing method, which may include that: first group chat voice information of a first user is received; a second user associated with the first group chat voice information is determined; and when the first group chat voice information is sent to a target chat group, the second user is marked as a target user of the first group chat voice information.

Optionally, the operation that the second user associated with the first group chat voice information is determined may include that: user information of each user in the target chat group is acquired; and the second user associated with the first group chat voice information in the target chat group is determined according to the user information of each user.

Optionally, the operation that the second user associated with the first group chat voice information in the target chat group is determined according to the user information of each user may include that: voice recognition is performed on the first group chat voice information to convert into text information corresponding to the first group chat voice information; the text information is processed to extract information meeting a preset rule from the text information; user information matched with the text information in the user information of each user is inquired according to the information meeting the preset rule; and a user corresponding to the user information matched with the text information is determined as the second user.

Optionally, the operation that the second user is marked as the target user of the first group chat voice information may include that: when the first group chat voice information is sent to the target chat group, a prompt is provided in a preset prompting style in a chat interface of the target chat group of the second user.

Optionally, the operation that the second user is marked as the target user of the first group chat voice information may include that: when the first group chat voice information is sent to the target chat group, at least one user associated with the first group chat voice information are prompted in a chat interface of the target chat group.

Another embodiment of the present disclosure provides a group chat voice information processing apparatus, which may include: a receiving unit, configured to receive first group chat voice information of a first user; a determination unit, configured to determine a second user associated with the first group chat voice information; and a marking unit, configured to mark, when the first group chat voice information is sent to a target chat group, the second user as a target user of the first group chat voice information.

Optionally, the determination unit may include: an information acquisition unit, configured to acquire user information of each user in the target chat group of the first group chat voice information; and a user determination unit, configured to determine the second user associated with the first group chat voice information in the target chat group according to the user information of each user.

Optionally, the user determination unit may include: a recognition sub-unit, configured to perform voice recognition on the first group chat voice information to convert into text information corresponding to the first group chat voice information; an extraction sub-unit, configured to process the text information to extract information meeting a preset rule from the text information; an inquiry sub-unit, configured to inquire user information matched with the text information in the user information of each user according to the information meeting the preset rule; and a determination sub-unit, configured to determine a user corresponding to the user information matched with the text information as the second user.

Optionally, the marking unit is configured to mark the second user as the target user of the first group chat voice information by the following step: when the first group chat voice information is sent to the target chat group, a prompt is provided in a preset prompting style in a chat interface of the target chat group of the second user.

Optionally, the marking unit is configured to mark the second user as the target user of the first group chat voice information by the following step: when the first group chat voice information is sent to the target chat group, at least one user associated with the first group chat voice information are prompted in the chat interface of the target chat group.

Another embodiment of the present disclosure provides a storage medium, which may have computer programs stored thereon. The computer programs, when executed by a processor, may implement steps of the method mentioned-above.

Another embodiment of the present disclosure provides a server, which may include a processor, a memory and computer programs that are stored on the memory and are controlled to run on the processor. The processor, when executing the computer programs, may implement steps of the method mentioned-above.

Another embodiment of the present disclosure provides a server, which may include the group chat voice information processing apparatus mentioned-above.

According to the technical solutions of the present disclosure, after group chat voice information sent by a first user is received, the second user associated with the group chat voice information in the target chat group is determined according to user information of each user in the target chat group, when the group chat voice information is sent to the target chat group, the second user is marked as the target user of the group chat voice information, and the second user is reminded. A user can be reminded when group chat voice information associated with the user exists in a chat group, so that the user can listen to the group chat voice information associated with this user in time, and unnecessary group chat voice information can be prevented from being listened by the user.

### BRIEF DESCRIPTION OF THE DRAWINGS

FIG. 1 is a flowchart of a group chat voice information processing method according to an embodiment of the present disclosure.

FIG. 2 is a flowchart of determining a second user associated with first group chat voice information according to an optional embodiment of the present disclosure.

FIG. 3 is a flowchart of determining a second user associated with first group chat voice information according to another optional embodiment of the present disclosure.

FIG. 4 is a schematic diagram of prompting at least one user associated with the first group chat voice information in a chat interface according to an optional embodiment of the present disclosure.

FIG. 5 is a structural schematic diagram of a group chat voice information processing apparatus according to an optional embodiment of the present disclosure.

FIG. 6 is a structural schematic diagram of a determination unit according to an optional embodiment of the present disclosure.

FIG. 7 is a structural schematic diagram of a user determination unit according to an optional embodiment of the present disclosure.

### DETAILED DESCRIPTION

In order that the objects, technical solutions, and advantages of the present disclosure will become more apparent, a photovoltaic module cleaning system of the present disclosure will now be described in further detail, by way of embodiments, with reference to the accompanying drawings. It is to be understood that the specific embodiments described herein are illustrative of the present disclosure and are not intended to limit the present disclosure.

FIG. 1 is a flowchart of a group chat voice information processing method according to an embodiment of the present disclosure. The method of the present disclosure may be implemented at a mobile terminal or server, for example, a server corresponding to chat software.

As shown in FIG. 1, in this embodiment of the present disclosure, the group chat voice information processing method includes at least steps S110, S120 and S130.

In step S110, first group chat voice information of a first user is received.

The first group chat voice information, i.e. information that is input by a user via voice in a group chat interface of a chat application, may be sent or to be sent. For example, the first group chat voice information is group chat voice information input by a user via voice in a group chat interface of a certain chat group of a chat application (APP) installed at a mobile terminal.

In step S120, a second user associated with the first group chat voice information is determined.

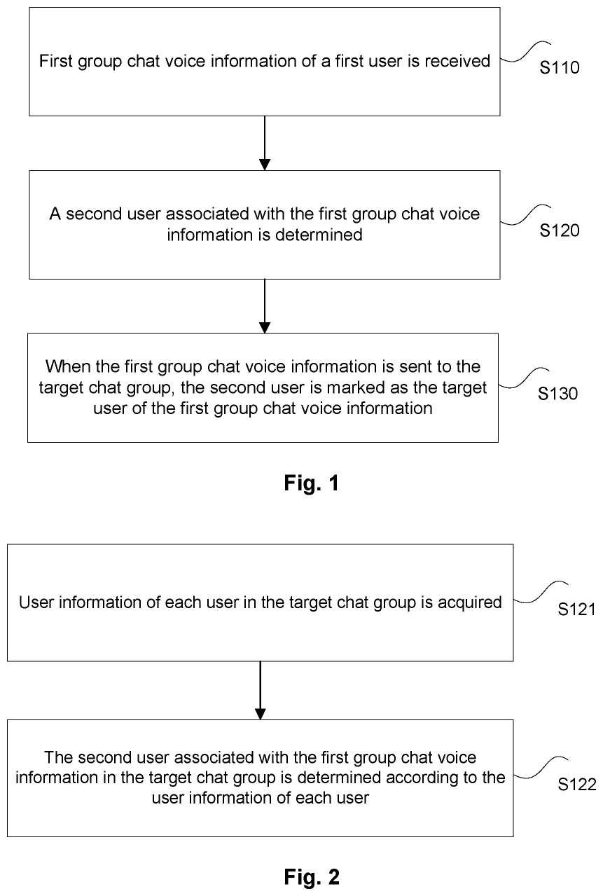

FIG. 2 is a flowchart of determining a second user associated with first group chat voice information according to an optional embodiment of the present disclosure.

As shown in FIG. 2, in a specific implementation manner, step S120 specifically includes step S121 and step S122.

In step S121, user information of each user in the target chat group is acquired.

Specifically, the target chat group includes at least two users. The user information may specifically include at least one of a user nickname (e.g., a WeChat nickname), a user group chat nickname (a nickname of a user in a current chat group), a user account (e.g., a WeChat ID), and a user real name.

In step S122, the second user associated with the first group chat voice information in the target chat group is determined according to the user information of each user.

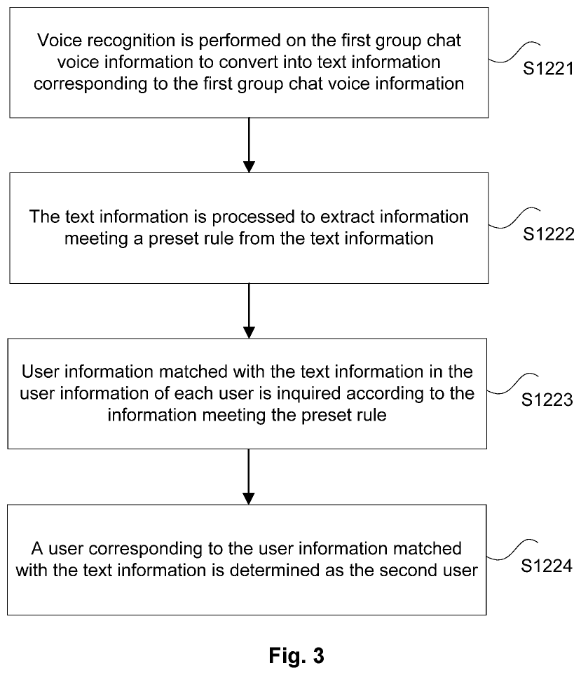

FIG. 3 is a flowchart of determining a second user associated with first group chat voice information according to another optional embodiment of the present disclosure. As shown in FIG. 3, in a specific implementation manner, step S122 specifically includes step S1221, step S1222, step S1223, and step S1224.

In step S1221, voice recognition is performed on the first group chat voice information to convert into text information corresponding to the first group chat voice information.

In step S1222, the text information is processed to extract information meeting a preset rule from the text information.

In step S1223, user information matched with the text information in the user information of each user is inquired according to the information meeting the preset rule.

In step S1224, a user corresponding to the user information matched with the text information is determined as the second user.

Specifically, the information meeting the preset rule may be name information, and the preset rule is a naming rule. For example, user A sends chat voice information that is voice-recognized and converted to text information as “Xiaoming, we'll go to Beijing next week, will you go?” Information extraction is performed on the text information, and when text information which is likely to be a name in the text information is extracted as “Xiaoming”, user information matched with “Xiaoming” is searched in the user information of each user of the target chat group according to “Xiaoming” in the group chat voice information, for example, whether a nickname of a user is “Xiaoming”, whether a nickname of a user in a chat group is “Xiaoming”, and whether a real name of a user is “Xiaoming”. When user information matched with “Xiaoming” is found, a user corresponding to the matched user information is determined as the second user associated with the group chat voice information sent by the first user.

In step S130, when the first group chat voice information is sent to the target chat group, the second user is marked as the target user of the first group chat voice information.

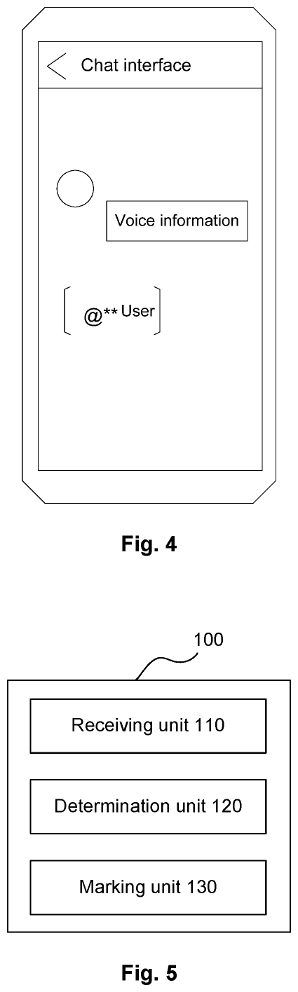

Specifically, the first group chat voice information is sent to the target chat group, the first group chat voice information is actually sent to each user in the target chat group, and each user may receive the same first group chat voice information in a client chat interface of chat software. In a specific implementation manner, when the first group chat voice information is sent to the target chat group, at least one user associated with the first group chat voice information are prompted in a chat interface of the target chat group (a chat interface of a client application installed at a terminal). When the method is implemented at a mobile terminal, the first group chat voice information is sent to a server, information of the associated users is simultaneously sent, and the server prompts the at least one user associated with the first group chat voice information in the chat interface of the target chat group when sending the first group chat voice information to the target chat group according to the information of the associated users. For example, FIG. 4 is a schematic diagram of prompting at least one user associated with the first group chat voice information in a chat interface according to an optional embodiment of the present disclosure. As shown in FIG. 4, a prompt of “@Xiaoming” is displayed in the chat interface of the target chat group, indicating that an associated user of the first group chat voice is Xiaoming. The user associated with the first group chat voice information may be prompted in the chat interface of the target chat group of each user of the target chat group, so that other users in the chat group can also know that the user associated with the first group chat voice information is the second user.

In another specific implementation manner, when the first group chat voice information is sent to the target chat group, a prompt is provided in a preset prompting style in a chat interface of the target chat group of the second user. The preset prompting style is different from prompting styles of other group chat voice information. That is, a prompting style of the first group chat voice information is displayed to be different from prompting styles of other group chat voice information in the client chat interface of the second user. When the method is implemented at a mobile terminal, the first group chat voice information is sent to a server, information of at least one user associated with the first group chat voice information is simultaneously sent, and the server prompts in the preset prompting style in the chat interface of the target chat group of the second user when sending the first group chat voice information to the target chat group according to the information of the at least one user. For example, in the chat interface of the target chat group of the second user, a background color of other group chat voice information is white. When sending the first group chat voice information to the second user, the background color of the first group chat voice information is displayed as a color different from white in the chat interface of the second user. Meanwhile, chat software on a terminal used by the second user may also prompt on the terminal, for example, displaying prompt information “There is associated voice information”.

In practice, in a group chat process of users A and B, users in the chat group send a lot of voice information, the user B does not have enough time to listen to the voice information in the group chat one by one due to busyness, and may miss the voice information of the user A to the user B. After the technical solutions of the present disclosure are adopted, when voice information sent by the user A is associated with the user B, for example, the name of the user B is mentioned, the server may specially process the voice information when sending the voice information to the corresponding chat group so as to prompt the user B that the voice information is associated with the user B, and the user B can be prevented from missing the voice information associated with the user B.

FIG. 5 is a structural schematic diagram of a group chat voice information processing apparatus according to an optional embodiment of the present disclosure. The apparatus of the present disclosure may be implemented at a mobile terminal or server, for example, a server corresponding to chat software.

As shown in FIG. 5, the group chat voice information processing apparatus 100 includes: a receiving unit 110, a determination unit 120 and a marking unit 130.

The receiving unit 110 is configured to receive first group chat voice information of a first user. The determination unit 120 is configured to determine a second user associated with the first group chat voice information. The marking unit 130 is configured to mark, when the first group chat voice information is sent to the target chat group, the second user as the target user of the first group chat voice information.

The receiving unit 110 receives first group chat voice information sent by a first user. The first group chat voice information, i.e. information that is input by a user via voice in a group chat interface of a chat application, may be sent or to be sent. For example, the first group chat voice information is group chat voice information input by a user via voice in a group chat interface of a certain chat group of a chat application (APP) installed at a mobile terminal.

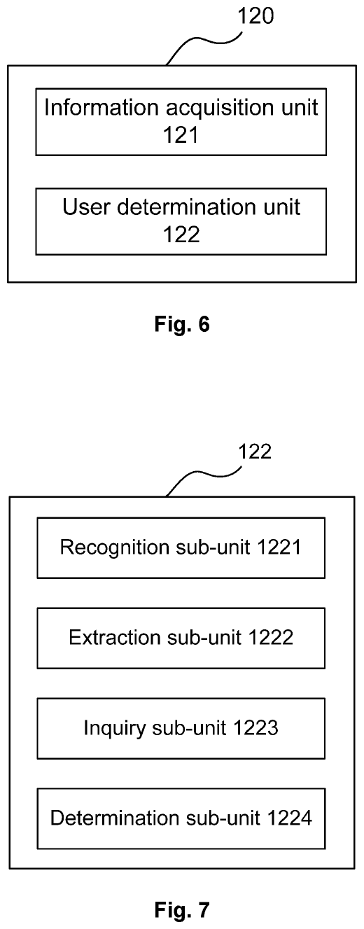

FIG. 6 is a structural schematic diagram of a determination unit according to an optional embodiment of the present disclosure. As shown in FIG. 6, in a specific implementation manner, the determination unit 120 includes an information acquisition unit 121 and a user determination unit 122.

The information acquisition unit 121 is configured to acquire user information of each user in the target chat group. The user determination unit 122 is configured to determine the second user associated with the first group chat voice information in the target chat group according to the user information of each user.

The information acquisition unit 121 acquires user information of each user in the target chat group. Specifically, the target chat group includes at least two users. The user information may specifically include at least one of a user nickname (e.g., a WeChat nickname), a user group chat nickname (a nickname of a user in a current chat group), a user account (e.g., a WeChat ID), and a user real name.

The user determination unit 122 determines the second user associated with the first group chat voice information in the target group chat group according to the user information of each user.

FIG. 7 is a structural schematic diagram of a user determination unit according to an optional embodiment of the present disclosure. As shown in FIG. 7, in a specific implementation manner, the user determination unit 122 includes a recognition sub-unit 1221, an extraction sub-unit 1222, an inquiry sub-unit 1223, and a determination sub-unit 1224.

The recognition sub-unit 1221 is configured to perform voice recognition on the first group chat voice information to convert into text information corresponding to the first group chat voice information. The extraction sub-unit 1222 is configured to process the text information to extract information meeting a preset rule from the text information. The inquiry sub-unit 1223 is configured to inquire user information matched with the text information in the user information of each user according to the information meeting the preset rule. The determination sub-unit 1224 is configured to determine a user corresponding to the user information matched with the text information as the second user.

Specifically, the information meeting the preset rule may be name information, and the preset rule is a naming rule. For example, user A sends chat voice information that is voice-recognized and converted by the recognition sub-unit 1221 to text information as “Xiaoming, we'll go to Beijing next week, will you go?” The extraction sub-unit 1222 performs information extraction is performed on the text information, and when text information which is likely to be a name in the text information is extracted as “Xiaoming”, the inquiry sub-unit 1223 searches for user information matched with “Xiaoming” in the user information of each user of the target chat group according to “Xiaoming” in the group chat voice information, for example, whether a nickname of a user is “Xiaoming”, whether a nickname of a user in a chat group is “Xiaoming”, and whether a real name of a user is “Xiaoming”. When user information matched with “Xiaoming” is found, the determination sub-unit 1224 determines a user corresponding to the user information as the second user associated with the group chat voice information sent by the first user.

The marking unit 130 marks the second user as the target user of the first group chat voice information.

Specifically, the first group chat voice information is sent to the target chat group, the first group chat voice information is actually sent to each user in the target chat group, and each user may receive the same first group chat voice information in a client chat interface of chat software. In a specific implementation manner, when the first group chat voice information is sent to the target chat group, the marking unit 130 prompts at least one user associated with the first group chat voice information in a chat interface of the target chat group (a chat interface of a client application installed at a terminal). When the apparatus is implemented at a mobile terminal, the first group chat voice information is sent to a server, information of the associated users is simultaneously sent, and the server prompts the at least one user associated with the first group chat voice information in the chat interface of the target chat group when sending the first group chat voice information to the target chat group according to the information of the associated users. For example, FIG. 4 is a schematic diagram of prompting at least one user associated with the first group chat voice information in a chat interface according to an optional embodiment of the present disclosure. As shown in FIG. 4, a prompt of “@Xiaoming” is displayed in the chat interface of the target chat group, indicating that an associated user of the first group chat voice is Xiaoming. The user associated with the first group chat voice information may be prompted in the chat interface of the target chat group of each user of the target chat group, so that other users in the chat group can also know that the user associated with the first group chat voice information is the second user.

In another specific implementation manner, when the first group chat voice information is sent to the target chat group, the marking unit 130 prompts in a preset prompting style in a chat interface of the target chat group of the second user. The preset prompting style is different from prompting styles of other group chat voice information. That is, a prompting style of the first group chat voice information is displayed to be different from prompting styles of other group chat voice information in the client chat interface of the second user. When the method is implemented at a mobile terminal, the first group chat voice information is sent to a server, information of at least one user associated with the first group chat voice information is simultaneously sent, and the server prompts in the preset prompting style in the chat interface of the target chat group of the second user when sending the first group chat voice information to the target chat group according to the information of the at least one user. For example, in the chat interface of the target chat group of the second user, a background color of other group chat voice information is white. When sending the first group chat voice information to the second user, the background color of the first group chat voice information is displayed as a color different from white in the chat interface of the second user. Meanwhile, chat software on a terminal used by the second user may also prompt on the terminal, for example, displaying prompt information “There is associated voice information”.

Another embodiment of the present disclosure also provides a storage medium corresponding to the group chat voice information processing method, which stores computer programs. The computer programs, when executed by a processor, implement the steps of the method mentioned-above.

Another embodiment of the present disclosure also provides a server corresponding to the group chat voice information processing method, which includes a processor, a memory and computer programs that are stored on the memory and are controlled to run on the processor. The processor, when executing the computer programs, implements the steps of the method mentioned-above.

Another embodiment of the present disclosure also provides a server corresponding to the group chat voice information processing apparatus, which includes the group chat voice information processing apparatus mentioned-above.

Therefore, according to the solutions provided by the present disclosure, after group chat voice information sent by the first user is received, the second user associated with the group chat voice information in the target chat group is determined according to user information of each user in the target chat group. When the group chat voice information is sent to the target chat group, the second user is marked as the target user of the group chat voice information, and the second user is reminded. A user can be reminded when group chat voice information associated with the user exists in a chat group, so that the user can listen to the group chat voice information associated with the user in time, and unnecessary group chat voice information can be prevented from being listened by the user.

The functions described herein may be implemented in hardware, software executed by a processor, firmware, or any combination thereof. When implemented in the software executed by the processor, the functions may be stored on or transmitted over as one or more instructions or code on a computer-readable medium. Other examples and implementation manners are within the scope and spirit of the present disclosure and appended claims. For example, due to the nature of software, the functions described above may be implemented using software executed by the processor, hardware, firmware, hard wires, or a combination thereof. In addition, each functional unit may be integrated into a processing unit, each unit may also physically exist independently, and two or more than two units may also be integrated into a unit.

In several embodiments provided by the present disclosure, it is to be understood that the disclosed technical content may be implemented in other manners. The apparatus embodiments described above are merely illustrative. For example, the division of the unit may be a logical function division. In actual implementation, there may be another division manner, for example, multiple units or components may be combined or integrated into another system, or some features may be ignored or not executed. In addition, the coupling or direct coupling or communication connection shown or discussed may be an indirect coupling or communication connection through some interfaces, units or modules, and may be electrical or otherwise.

The units described as separate components may or may not be physically separated, and the members serving as control apparatuses may or may not be physical units, that is, may be located in one place, or may be distributed to multiple units. Some or all of the units may be selected according to actual needs to achieve the purpose of the solution of the present embodiment.

The integrated unit may be stored in a computer-readable storage medium when being implemented in the form of a software functional unit and sold or used as a standalone product. Based on such an understanding, the technical solution of the present disclosure, which is essential or contributes to the related art, may be embodied in the form of a software product. The computer software product is stored in a storage medium, including a number of instructions for causing a terminal apparatus (which may be a personal computer, a server, or a network apparatus, etc.) to perform all or part of the steps of the methods described in various embodiments of the present disclosure. The foregoing storage medium includes: a U disk, a Read-Only Memory (ROM), a Random Access Memory (RAM), a mobile hard disk, a magnetic disk, or an optical disk, and the like, which may store a program code.

The technical features of the above-described embodiments may be arbitrarily combined. For the sake of brevity of description, all possible combinations of the technical features in the above embodiments are not described. However, as long as there is no contradiction between the combinations of these technical features, all should be considered as the scope of this description.

The above embodiments are illustrative of several implementation manners of the present disclosure with specific and detailed description, and are not to be construed as limiting the patent scope of the present disclosure. It is to be noted that a number of variations and modifications may be made by those of ordinary skill in the art without departing from the conception of the present disclosure, and all fall within the scope of protection of the present disclosure. Therefore, the scope of protection of the present disclosure should be determined by the appended claims.

What is claimed is:

1. A group chat voice information processing method, comprising:
receiving first group chat voice information of a first user;
determining a second user associated with the first group chat voice information; and
when the first group chat voice information is sent to a target chat group, marking the second user as a target user of the first group chat voice information.

2. The method as claimed in claim 1, wherein determining the second user associated with the first group chat voice information comprises:
acquiring user information of each user in the target chat group; and
determining the second user associated with the first group chat voice information in the target chat group according to the user information of each user.

3. The method as claimed in claim 2, wherein determining the second user associated with the first group chat voice information in the target chat group according to the user information of each user comprises:
performing voice recognition on the first group chat voice information to convert into text information corresponding to the first group chat voice information;
processing the text information to extract information meeting a preset rule from the text information;
inquiring user information matched with the text information in the user information of each user according to the information meeting the preset rule; and
determining a user corresponding to the user information matched with the text information as the second user.

4. The method as claimed in claim 1, wherein marking the second user as the target user of the first group chat voice information comprises:
when the first group chat voice information is sent to the target chat group, prompting in a preset prompting style in a chat interface of the target chat group of the second user.

5. The method as claimed in claim 1, wherein marking the second user as the target user of the first group chat voice information comprises:
when the first group chat voice information is sent to the target chat group, prompting at least one user associated with the first group chat voice information in a chat interface of the target chat group.

6-10. (canceled)

11. A non-transitory storage medium, storing computer programs, wherein the computer programs, when executed by a processor, implement the following steps:
receiving first group chat voice information of a first user;
determining a second user associated with the first group chat voice information; and
when the first group chat voice information is sent to a target chat group, marking the second user as a target user of the first group chat voice information.

12. A server, comprising a processor, a memory and computer programs that are stored on the memory and are controlled to run on the processor, wherein the processor, when executing the computer programs, implements the following steps:
receiving first group chat voice information of a first user;
determining a second user associated with the first group chat voice information; and
when the first group chat voice information is sent to a target chat group, marking the second user as a target user of the first group chat voice information.

13. (canceled)

14. The server as claimed in claim 12, wherein the processor, when executing the computer programs, further implements the following steps:
acquiring user information of each user in the target chat group; and
determining the second user associated with the first group chat voice information in the target chat group according to the user information of each user.

15. The server as claimed in claim 14, wherein the processor, when executing the computer programs, further implements the following steps:
performing voice recognition on the first group chat voice information to convert into text information corresponding to the first group chat voice information;
processing the text information to extract information meeting a preset rule from the text information;
inquiring user information matched with the text information in the user information of each user according to the information meeting the preset rule; and
determining a user corresponding to the user information matched with the text information as the second user.

16. The server as claimed in claim 12, wherein the processor, when executing the computer programs, further implements the following steps:
when the first group chat voice information is sent to the target chat group, prompting in a preset prompting style in a chat interface of the target chat group of the second user.

17. The server as claimed in claim 12, wherein the processor, when executing the computer programs, further implements the following steps:
when the first group chat voice information is sent to the target chat group, prompting at least one user associated with the first group chat voice information in a chat interface of the target chat group.

18. The method as claimed in claim 2, wherein the user information comprises at least one of a user nickname, a user group chat nickname, a user account and a user real name.

19. The method as claimed in claim 3, wherein the information meeting the preset rule is name information, and the preset rule is a naming rule.

20. The method as claimed in claim 4, wherein the preset prompting style is different from prompting styles of other group chat voice information.
